(19) United States
(12) Patent Application Publication
(10) Pub. No.: US 2012/0014260 A1
(43) Pub. Date: Jan. 19, 2012

(54) COMMUNICATION DEVICE IN COMMUNICATION NETWORK AND COMMUNICATION CONTROL METHOD

(76) Inventor: Naoki Enomoto, Tokyo (JP)

(21) Appl. No.: 13/138,740

(22) PCT Filed: Mar. 18, 2010
(86) PCT No.: PCT/JP2010/001936

§ 371 Date: Sep. 23, 2011

(30) Foreign Application Priority Data
Mar. 31, 2009 (JP) 2009-084771

(51) Int. Cl. H04L 12/26

(52) U.S. Cl. 370/241.1; 370/252

(57) ABSTRACT

A communication control method and a communication device are provided by which the communication quality of an upper layer can be ensured at a lower layer. The communication device that is connected to another communication device to constitute a network, includes a upper-layer quality detection section (105, 106) that detects quality information of communication traffic of an upper layer higher than a predetermined layer, and a lower-layer control section (107) that controls communication of the predetermined layer based on the quality information on the upper layer so as to guarantee communication quality of the upper layer. When a plurality of paths passing through the communication device coexist, the lower-layer control section can share the quality information of the upper layer of these paths in respect to path control and further can switch the route of a path other than a path in which the communication quality of the upper layer has degraded.

### TECHNICAL FIELD

The present invention relates to a communication control method and a communication device for ensuring communication quality in a communication network.

### BACKGROUND ART

In recent years, Ethernet (registered trademark, the same will apply hereinafter) is becoming widespread in communication networks, and with this proliferation, there is more need for network quality. In current networks, the adopted concept is that each layer ensures quality and, if a layer cannot ensure quality, escalation is made to an upper layer, where operation is performed with consideration given to the quality of the lower layer.

For example, in Ethernet, multiplexing is performed at Layer 2. If the quality of traffic can be guaranteed at Layer 2, it is also possible to guarantee quality at upper layers. Patent literature PTL 1 discloses a communication control device that, with provision of a QOS table managing the service quality of each network at the transport layer (Layer 4), refers to this QOS table and selects a network appropriate to service quality requested by an upper layer (Layer 5 or higher). Moreover, at the application layer, blocking is performed for networks by using a firewall or the like, whereby quality is ensured.

### CITATION LIST

### Patent Literature

### [PTL 1]

Japanese Patent Application Unexamined Publication No. H06-276254.

### SUMMARY OF INVENTION

### Technical Problem

In this manner, escalation is made from a lower layer to an upper layer, where operation is performed with consideration given to the quality of the lower layer. However, there is no mechanism to make escalation from a upper layer to a lower layer. Therefore, it is impossible to ensure the quality of an upper layer at a lower layer.

An object of the present invention is to provide a communication control method and a communication device that make it possible to ensure the communication quality of an upper layer at a lower layer.

### Solution to Problem

A communication device according to the present invention is a communication device connected to other communication devices to constitute a network, characterized by comprising: detection means for detecting quality information of communication traffic at an upper layer higher than a predetermined layer; and control means for controlling communication of the predetermined layer based on the quality information of the upper layer so as to guarantee communication quality of the upper layer.

A communication control method according to the present invention is a communication control method for a communication device connected to other communication devices to constitute a network, characterized by comprising: detecting quality information of communication traffic at an upper layer higher than a predetermined layer; and controlling communication of the predetermined layer based on the quality information of the upper layer so as to guarantee communication quality of the upper layer.

A communication system according to the present invention is a communication system in which a plurality of communication devices are connected to constitute a network, characterized in that each of the plurality of communication devices comprises: detection means for detecting quality information of communication traffic at an upper layer higher than a predetermined layer; and control means for controlling communication of the predetermined layer based on the quality information of the upper layer so as to guarantee communication quality of the upper layer.

### ADVANTAGEOUS EFFECTS OF INVENTION

According to the present invention, it is possible to ensure the communication quality of an upper layer at a lower layer.

### BRIEF DESCRIPTION OF DRAWINGS

[FIG. 1]

FIG. 1A is a schematic diagram showing a communication control method according to an embodiment of the present invention, FIG. 1B is a schematic diagram showing a communication control method according to an example of the present invention, and FIG. 1C is a schematic diagram showing a communication control method according to another example of the present invention.

[FIG. 2]

FIG. 2 is a block diagram showing a functional configuration of a communication device according to the embodiment of the present invention.

[FIG. 3]

FIG. 3 is a network diagram showing an example of a network to which the present invention is applied.

[FIG. 4]

FIG. 4 is a block diagram showing a functional configuration of a communication device according to a first example of the present invention.

[FIG. 5]

FIG. 5 is a format diagram showing VSM of an Ethernet OAM frame in the first example of the present invention.

[FIG. 6]

FIG. 6 is a format diagram showing VSR of an Ethernet OAM frame in the first example of the present invention.

[FIG. 7]

FIG. 7 is a diagram showing a table of parameters of TLV information in the first example of the present invention.

[FIG. 8]

FIG. 8 is a network diagram showing routes of VLAN paths A in the network shown in FIG. 3.

[FIG. 9]

FIG. 9 is a network diagram showing routes of VLAN paths B in the network shown in FIG. 3.

[FIG. 10]

FIG. 10 is a network diagram showing primary routes of the VLAN paths A and B in the network shown in FIG. 3.

[FIG. 11]

FIG. 11 is a network diagram for describing route switching operation of the communication device shown in FIG. 4.

[FIG. 12]

FIG. 12 is a block diagram showing a functional configuration of a communication device according to a second example of the present invention.

### DESCRIPTION OF EMBODIMENTS

### 1. Embodiment

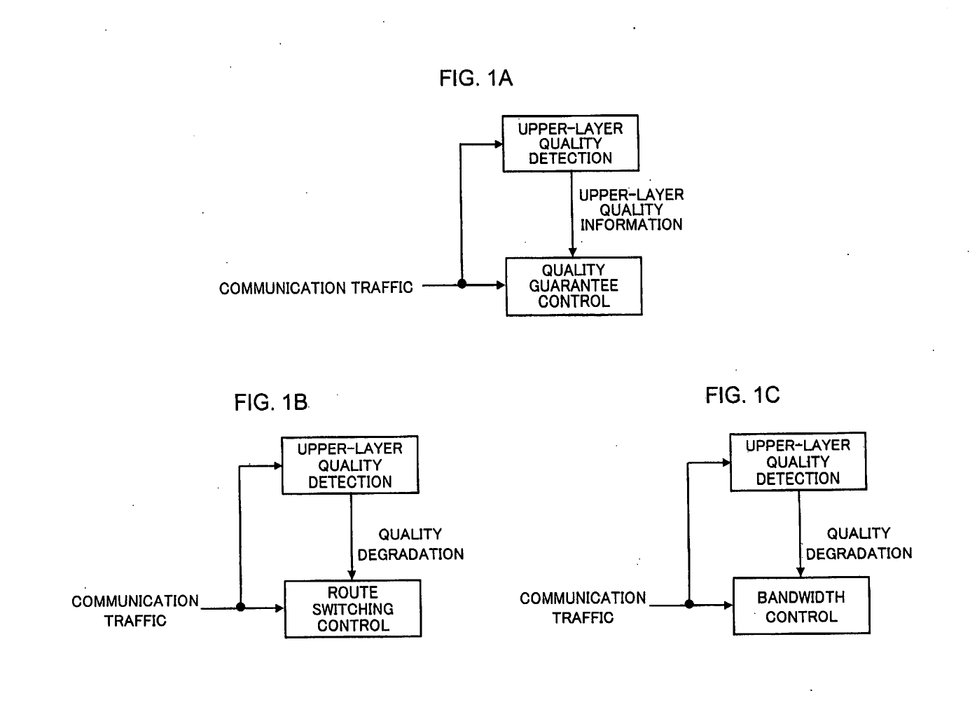

As shown in FIG. 1A, according to an embodiment of the present invention, a lower layer acquires quality information on communication traffic from an upper layer and guarantees quality of the traffic. The quality information on the upper layer includes, for example, information on whether or not a virus is detected, information on whether or not real-time processing is required, or the like. The way of guaranteeing quality depends on the functionality of the lower layer. For example, in the case where the lower layer is Layer 2, route switching and bandwidth control are performed by using the quality information on Layer 3 or an upper layer, whereby quality can be ensured at a Layer-2 network.

As shown in FIG. 1B, when degradation in the quality of a path is detected at an upper layer, route switching to a path other than the degraded path is performed by using a switching function of a lower layer, whereby communication quality can be ensured at a Layer 2 network. Moreover, as shown in FIG. 1C, when degradation in quality is detected at an upper layer, the bandwidth of a path concerned is reduced at Layer 2, whereby the communication quality of a path other than the path concerned can be ensured at a Layer-2 network.

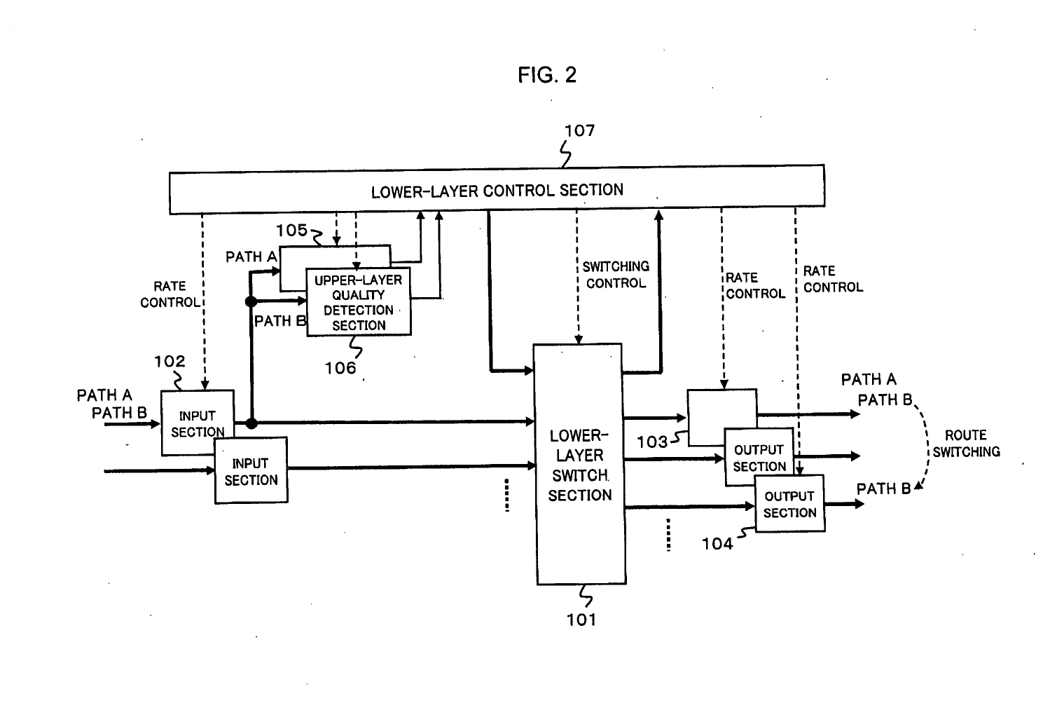

Next, an example of the functional configuration of a communication device according to the present embodiment will be described with reference to FIG. 2. Assuming a network in which a plurality of the communication devices (nodes) each shown in FIG. 2 are connected, it is assumed here that a node of interest exists on the routes of two paths A and B.

Referring to FIG. 2, the communication device according to the present embodiment is provided with a lower-layer switch section 101, a plurality of input sections are connected to a plurality of input ports of the lower-layer switch section 101, and a plurality of output sections are connected to a plurality of output ports thereof. Here, a description will be given of control to change the connection state of the lower-layer switch section 101 from a state where the paths A and B are connected to an input section 103 to a state where the paths A and B are connected to the output section 103 and an output section 104, respectively.

In the communication control device according to the present embodiment, an upper-layer quality detection function is further provided for each path. Here, an upper-layer quality detection section 105 is provided for the path A, and an upper-layer quality detection section 106 is provided for the path B. A lower-layer control section 107, depending on the presence or absence of degradation in the quality of an upper layer, performs switching control of the lower-layer switch section 101, rate control of the input sections and output sections, and/or the like.

For example, when the lower-layer switch section 101 is in a connection state of transferring the paths A and B to the output section 103, it is assumed that the upper-layer quality detection section 105 has detected degradation in the quality of the path A. Upon receipt of a notification of the path-A quality degradation from the upper-layer quality detection section 105, the lower-layer control section 107, in order to separate these paths, switches the route of the other path B to the output section 104. For a procedure of this route switching, it is sufficient to execute in accordance with a route switching function of the lower layer. Moreover, apart from route switching, it is also possible to perform bandwidth control of the input section 102 and the output section 103.

As described above, according to the present embodiment, communication control of the communication device or network is performed in such a manner that a lower layer acquires quality information on communication traffic from an upper layer and guarantees quality of the traffic, whereby the communication quality of the upper layer can be ensured at the lower layer.

### 2. First Example

### 2.1) Network

According to a first example of the present invention, using Ethernet OAM (operations, administration, maintenance), which has been discussed by IEEE and ITU-T, quality information on an upper layer is developed at each node within a network, whereby a mechanism to make escalation from an upper layer to a lower layer is realized. In the present example, upper layer information on Layer 3 or an upper layer is used for quality information on communication traffic, and network management operation is performed at a Layer-2 network by using Ethernet OAM.

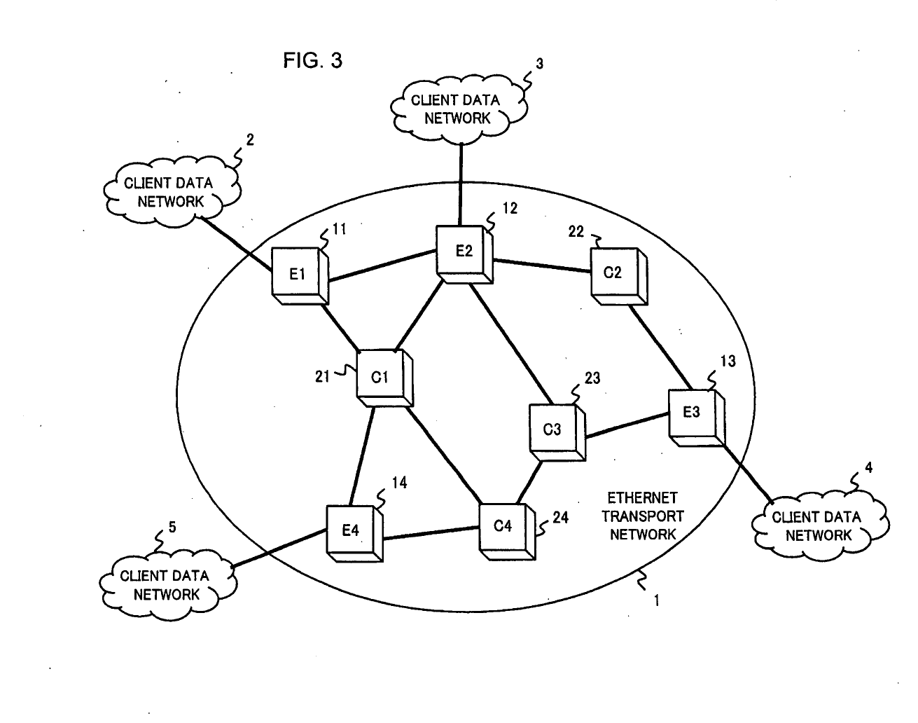

First, to describe operations according to the present example, a network shown in FIG. 3 is assumed. The Ethernet transport network (hereinafter, referred to as network 1) includes a plurality of nodes, and each node is provided with a Layer-2 switch function, a function of acquiring quality information on communication traffic from an upper layer, and a function of controlling the network 1.

The nodes constituting the network 1 include edge nodes 11 to 14, each having an interface (client interface) connecting to a client data network (hereinafter, referred to as client network), and core nodes 21 to 24, each having no client interface. The difference between these two types of nodes is only the presence or absence of a client interface. Even a core node can be an edge node if it has a client interface.

In such a network 1, it is assumed that a plurality of VLANs (Virtual LANs) are set up between a plurality of client networks and that two routes, a primary route and a secondary route, are predetermined for each VLAN.

### 2.2) Node Configuration

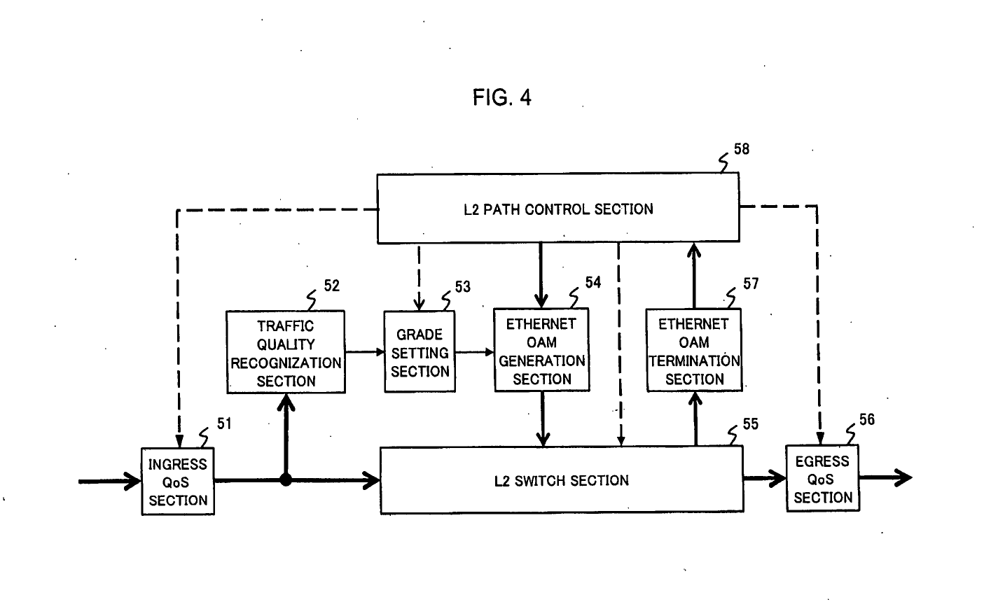

It is assumed that a communication control system related to the present example of any of the edge nodes 11 to 14 and core nodes 21 to 24 in the network shown in FIG. 3 has the same configuration. Hereinafter, the communication control system of each node will be described with reference to FIG. 4.

As shown in FIG. 4, the node according to the present example includes an ingress QoS section 51, a traffic quality recognition section 52, a grade setting section 53, an Ethernet OAM generation section 54, a L2 switch section 55, an egress QoS section 56, an Ethernet OAM termination section 57, and a L2 path control section 58. Of these sections, the traffic quality recognition section 52, grade setting section 53, Ethernet OAM generation section 54, and Ethernet OAM termination section 57 exist for each VLAN group.

The ingress QoS section 51 receives an input of communication traffic from a client network or an adjacent edge/core node, performs QoS (Quality of Service) processing in accordance with rate control information from the L2 path control section 58, and outputs the communication traffic to the traffic quality recognition section 52 and L2 switch section 55. The egress QoS section 56 performs QoS processing on communication traffic output from the L2 switch section 55 in accordance with rate control information from the L2 path control section 58 and sends the communication traffic out to an adjacent edge/core node or a client network. The ingress QoS section 51 and egress QoS section 56 are each provided with queues for QoS processing, and rate control is performed on the queues in accordance with the rate control information from the L2 path control section 58. However, since the QoS processing performed here is general queuing processing, a description thereof will be omitted.

The traffic quality recognition section 52 receives communication traffic from the ingress QoS section 51, performs pattern matching for quality determination on this received traffic, and outputs a result thereof to the grade setting section 53. This pattern matching for quality determination is executed on a communication packet or data in the packet, which is captured from the communication traffic as is captured by a LAN analyzer. Moreover, a pattern used for matching is a known virus data pattern, VoIP (Voice over IP) communication packet pattern, or the like. If a match occurs with the virus data pattern, it is determined that the quality of the communication traffic is “Degrade.” If a match occurs with the VoIP communication packet pattern, it is determined that the quality of the communication traffic is “Securely.”

The grade setting section 53 receives a result of pattern matching from the traffic quality recognition section 52 and also receives information on Valid/Invalid of grade setting from the L2 path control section 58. If the grade setting is Valid, the grade setting section 53 determines a grade of the quality of the communication traffic and an action ID based on the received result of pattern matching and on the service type of the path and outputs them to the Ethernet OAM generation section 54. If the grade setting is Invalid, the grade setting section 53 discards the received result of pattern matching and passes the information of Invalid to the Ethernet OAM generation section 54.

Note that the service type of a path is periodically set by an external network management system. Moreover, a grade of the quality of communication traffic is determined by counting the above-described “Degrade” or “Securely” of the quality of the communication traffic, based on the service type.

The Ethernet OAM generation section 54, in the case of receiving a grade of the quality of communication traffic (Grade) and an action identification (Action ID), generates VSM (Vendor Specific Message) or VSR (Vendor Specific Reply) of an Ethernet OAM frame by using TLV (Type, Length, Value) information input from the L2 path control section 58. The generated Ethernet OAM frame is output to the L2 switch section 55. Note that when the information of Invalid is received from the grade setting section 53, an Ethernet OAM frame is not generated.

The L2 switch section 55, upon receipt of communication traffic from the ingress QoS section 51 and an Ethernet OAM frame from the Ethernet OAM generation section 54, performs L2 switching processing on the received communication traffic and Ethernet OAM frame and then transfers them to the egress QoS section 56 and/or Ethernet OAM termination section 57. Moreover, when protection switching information is received from the L2 path control section 58, switching of transmission targets is executed on the L2 switch section 55. A description of the switching of transmission targets based on the protection switching information will be omitted because it is a method in conformity with the protection standards for Layer-2 networks.

The egress QoS section 56 performs QoS processing on communication traffic received from the L2 switch section 55 and sends it to a client network or an adjacent edge/core node. Moreover, the egress QoS section 56 receives rate control information from the L2 path control section 58 and performs rate control on queues under QoS processing.

The Ethernet OAM termination section 57 receives an Ethernet OAM frame from the L2 switch section 55, checks the normality of the Ethernet OAM frame, and outputs TLV information in the Ethernet OAM frame and information on the source of the Ethernet OAM frame to the L2 path control section 58.

The L2 path control section 58 receives TLV information and information on the source of an Ethernet OAM frame from the Ethernet OAM termination section 57 and performs rate control of the ingress QoS section 51 and egress QoS section 56 and switching control of the L2 switch section 55, depending on which one of VSM and VSR the TLV information is and on whether the Ethernet OAM frame is one that has been generated by its own node or has been received from another node, which will be described later.

It is noted that, the ingress QoS section 51 corresponds to the input section (102) in FIG. 2; the traffic quality recognition section 52 and grade setting section 53 correspond to the upper-layer quality detection section (105, 106) in FIG. 2; the L2 switch section 55 corresponds to the lower-layer switch section 101 in FIG. 2; the Ethernet OAM generation section 54, Ethernet OAM termination section 57, and L2 path control section 58 correspond to the lower-layer control section (107) in FIG. 2; and the egress QoS section 56 corresponds to the output section (103, 104) in FIG. 2.

Moreover, the traffic quality recognition section 52, grade setting section 53, Ethernet OAM generation section 54, Ethernet OAM termination section 57, and L2 path control section 58 can also be implemented by executing programs on a program-controlled processor such as a CPU (Central Processing Unit).

### 2.3) TLV Information

Hereinafter, a description will be given of TLV information in an Ethernet OAM frame used in the present example.

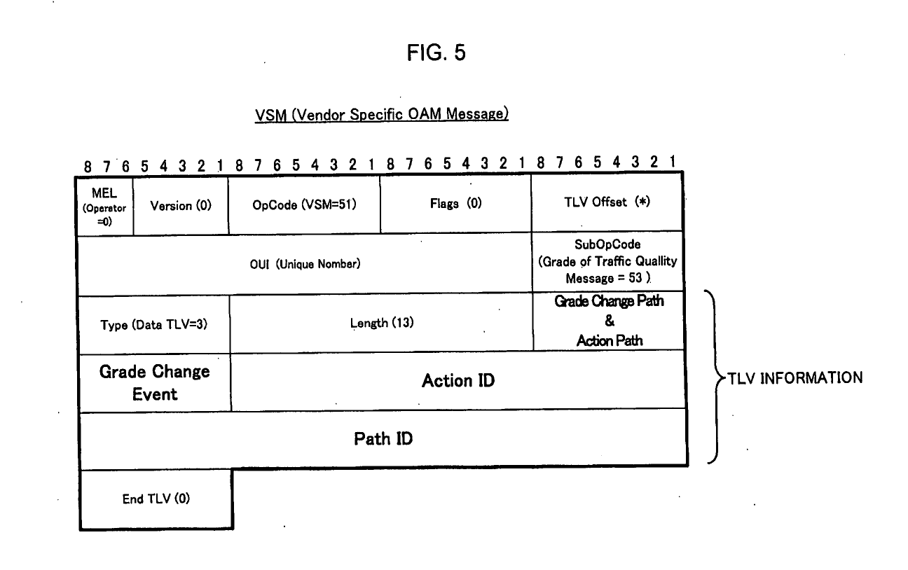

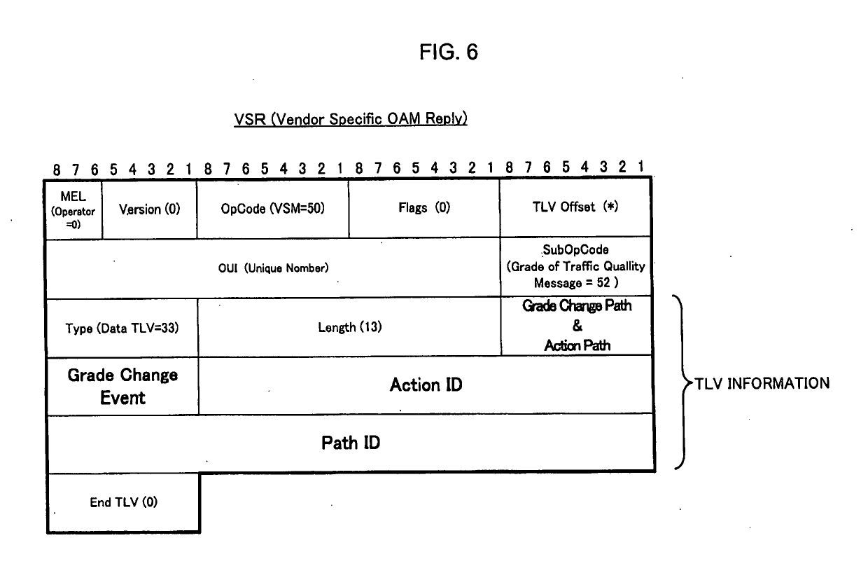

Referring to VSM shown in FIG. 5 and VSR shown in FIG. 6, in the TLV information, “Grade Change Path & Action Path” is a field specifying a path whose grade has changed (grade change path) and an action-target path (action path); “Grade Change Event” is a field indicating an increase or a decrease in the grade; “Action ID” is a field specifying the type of an action (route switching, rate control) on the action path; and “Path ID” is a field indicating the ID of the path in question.

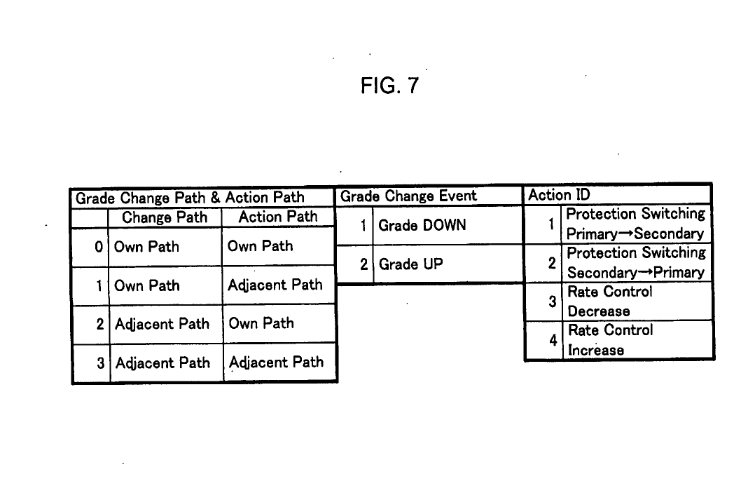

Specifically, as shown in FIG. 7, a parameter value “0” of “Grade Change Path & Action Path” indicates that the grade of the own path has changed so that the own path becomes an action target; a parameter value “1” indicates that the grade of the own path has changed so that an adjacent path becomes an action target; a parameter value “2” indicates that the grade of an adjacent path has changed so that the own path becomes an action target; and a parameter value “3” indicates that the grade of an adjacent path has changed so that the adjacent path becomes an action target.

Parameter values “1” and “2” of “Grade Change Event” indicate a decrease and an increase in the grade, respectively.

A parameter value “1” of “Action ID” indicates protection switching information to switch routes from the primary route to the secondary route; a parameter value “2” indicates protection switching information to switch routes from the secondary route to the primary route; a parameter value “3” indicates rate control information to reduce the rate; and a parameter value “4” indicates rate control information to increase the rate.

### 2.4) Route Switching Operation in Network

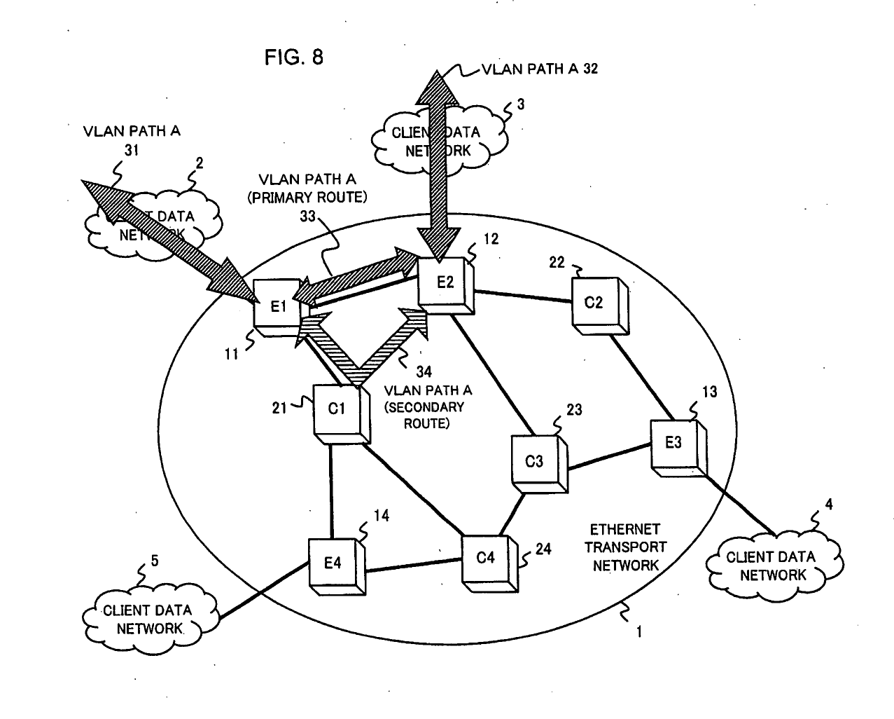

First, it is assumed that two VLAN groups A and B are set up in the network 1 and that parts of the primary routes of these VLAN groups pass through a link between the same nodes. An example is as shown in FIGS. 8 to 10.

FIG. 8 shows communication paths of the VLAN group A for allowing communication between client networks 2 and 3. The communication paths of the VLAN group A include a VLAN path A 31 between the client network 2 and edge node 11, a VLAN path A 32 between the edge node 12 and client network 3, a VLAN path A 33 representing the primary route of the VLAN group A within the network 1, and a VLAN path A 34 representing the secondary route of the VLAN group A.

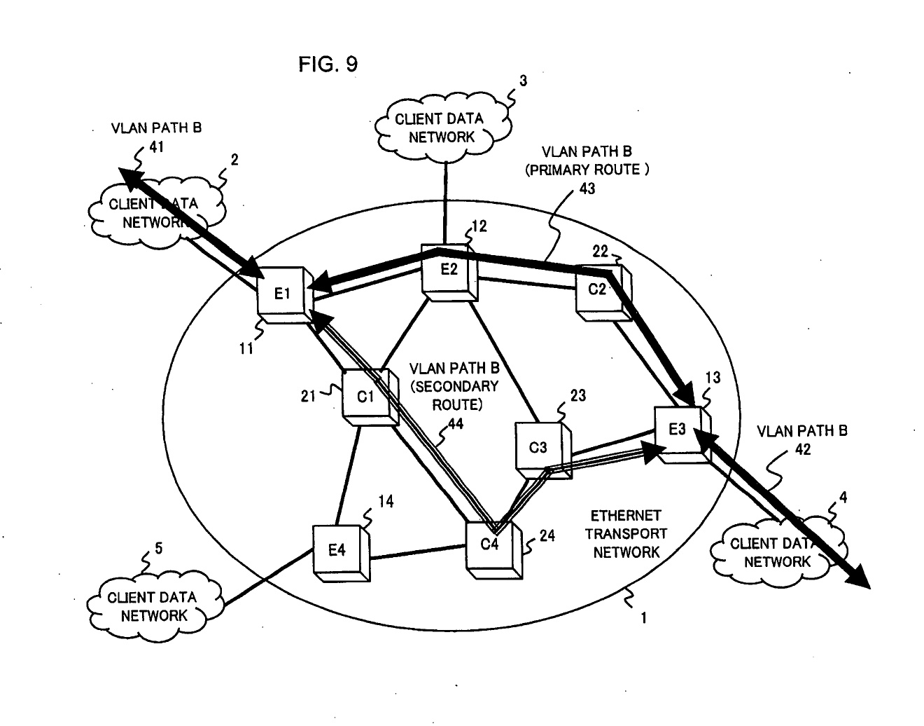

FIG. 9 shows communication paths of the VLAN group B for allowing communication between the client network 2 and a client network 4. The communication paths of the VLAN group B include a VLAN path B 41 between the client network 2 and edge node 11, a VLAN path B 42 between the edge node 13 and client network 4, a VLAN path B 43 representing the primary route of the VLAN group B within the network 1, and a VLAN path B 44 representing the secondary route of the VLAN group B.

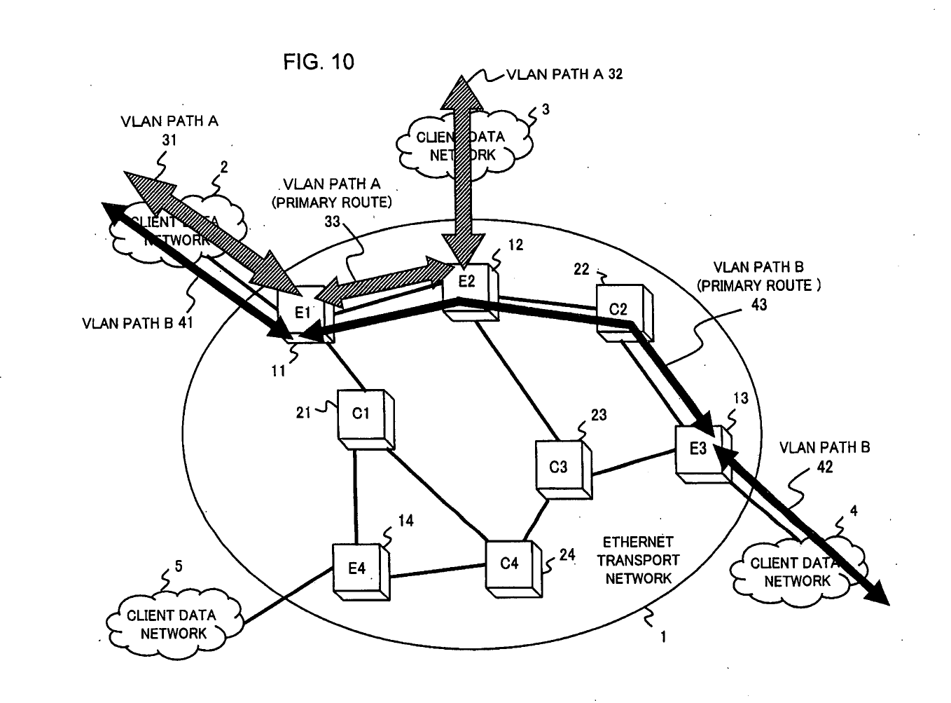

Further, when the VLAN group A allowing communication between the client networks 2 and 3 and the VLAN group B allowing communication between the client networks 2 and 4 each select the communication path of the primary route within the network 1, it is assumed that the respective paths coexist between the edge nodes 11 and 12, as shown in FIG. 10.

In the state where the respective primary routes are selected as shown in FIG. 10, it is assumed that the edge node 11 having received communication traffic of the VLAN group A from the client network 2 detects degradation in the quality of an upper layer. In this case, the edge node 11 starts communication control to switch the VLAN path B, which is adjacent to the VLAN path A whose grade has degraded, from the primary route 43 to the secondary route 44 by using an Ethernet OAM frame, which will be described next.

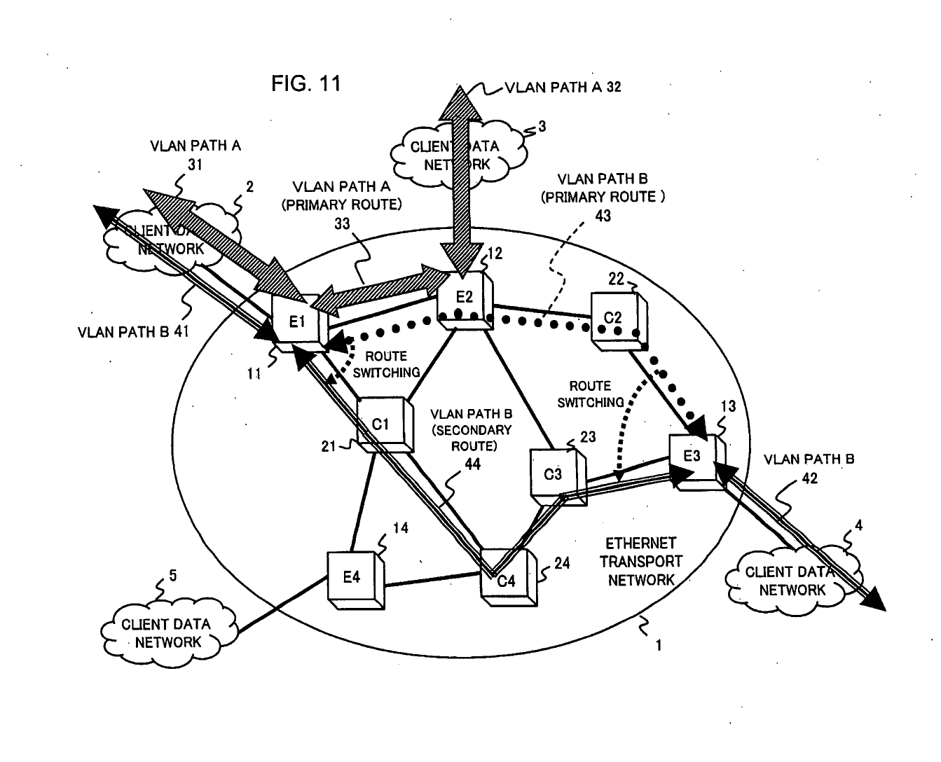

FIG. 11 shows a state where the selected path of the VLAN group B is switched from the primary route 43 to the secondary route 44 while the VLAN group A is in the state of selecting the primary route 33. Thereby, the VLAN group B leaves the path between the edge nodes 11 and 12, and the state of coexistence is dissolved.

In this manner, quality information on an upper layer is monitored from communication traffic input from a client network to an edge node, and the information is developed at each node in the network 1 when degradation in quality occurs, whereby it is possible for each node to ensure the quality of the upper layer at the Layer-2 level. Hereinafter, the operation according to the present example will be described in more details.

### 2.5) Communication Control Operation of Node

Hereinafter, a detailed description will be given of communication control operation according to the present example with reference to FIGS. 4 to 7 and 11. Here, a description will be given by taking as an example a case where, when the VLAN groups A and B are in the state of selecting their respective primary routes 33 and 43, degradation occurs due to a virus or the like in the quality of communication traffic in the VLAN group A from the client network 2 toward the client network 3.

### 2.5.1) Operation of Edge Node 11

As shown in FIG. 4, the ingress QoS section 51 of the edge node 11 first receives communication traffic containing a factor for degradation in the quality of the communication traffic such as a virus from the client network 2, performs QoS processing, and outputs the communication traffic to the traffic quality recognition section 52 and the L2 switch section 55. At this time, rate control is not performed because no rate control information is indicated by the L2 path control section 58.

The traffic quality recognition section 52, upon receipt of the communication traffic from the ingress QoS section 51, performs pattern matching with a plurality of patterns to determine the quality of the traffic. Since the received communication traffic contains a quality degradation factor such as a virus, a match occurs with a virus data pattern, and the quality is recognized as Degrade. This pattern matching result is output to the grade setting section 53.

If “Valid,” which validates the grade setting, has been input from the L2 path control section 58, the grade setting section 53, based on the pattern matching result indicating “Degrade” from the traffic quality recognition section 52 and on the service type of the path in question, determines that the grade of the communication traffic quality has degraded “Grade DOWN” and that the type of an action (Action ID) is to switch from the primary route to the secondary route, “Primary→Secondary.” The grade setting section 53 outputs the grade of the communication traffic quality and the action ID to the Ethernet OAM generation section 54.

The Ethernet OAM generation section 54, upon receipt of the grade of the communication traffic quality and the action ID from the grade setting section 53, sets the parameter values of “Grade Change Event” and “Action ID” of the TLV information in the VSM Ethernet OAM frame shown in FIG. 5 for “1” and “1” respectively (see FIG. 7). Moreover, “Grade Change Path & Action Path” is set for a parameter value of “1” for “Own Path & Adjacent Path” based on the VLAN ID and service type of the path, and Path ID is set for the LAN ID of the VLAN path A whose quality grade has changed. That is, the path whose grade has changed is the own path, and the target path of the route switching action is the adjacent path (VLAN path B). The Ethernet OAM generation section 54 outputs the thus generated VSM Ethernet OAM frame to the L2 switch section 55.

The L2 switch section 55, upon receipt of the communication traffic from the ingress QoS section 51, performs L2 switching processing and passes the communication traffic to the egress QoS section 56. Moreover, upon receipt of the VSM Ethernet OAM frame from the Ethernet OAM generation section 54, the L2 switch section 55 similarly performs L2 switching processing and passes the VSM Ethernet OAM frame to the Ethernet OAM termination section 57 and egress QoS section 56. At this time, route switching processing is not performed because no instruction for protection switching based on protection switching information is made from L2 path control section 58.

The egress QoS processing section 56, upon receipt of the communication traffic from the L2 switch section 55, performs QoS processing and sends the communication traffic to the edge node 12, which is an adjacent node through which the VLAN path A 33 (primary route) passes. At this time, rate control is not performed because no rate control information is indicated from the L2 path control section 58.

The Ethernet OAM termination section 57, upon receipt of the VSM Ethernet OAM frame generated by its own node from the L2 switch section 55, checks the normality of the Ethernet OAM frame and outputs the VSM TLV information in the Ethernet OAM frame and information on the source of the Ethernet OAM frame to the L2 path control section 58. As described above, in this TLV information, set are those parameters which indicate that the grade change path is the own path, that the action path is the adjacent path (VLAN path B), and that the action type (Action ID) is to switch from the primary route to the secondary route, “Primary→Secondary.”

The L2 path control section 58, when first determining that the Ethernet OAM frame in question is a VSM one and that the source thereof is the own node, refers to the TLV information and, for the action path in “Grade Change Path & Action Path,” outputs protection switching information based on the action ID to the L2 switch section 55.

Moreover, the L2 path control section 58 outputs, to the Ethernet OAM generation section 54 provided for the VLAN group of the adjacent path, TLV information in which the grade change path is changed to “Adjacent path” and the action path is inversed from Adjacent Path to Own Path in the “Grade Change Path & Action Path” information. Moreover, the L2 path control section 58 outputs Valid/Invalid information for grade setting indicative of “Invalid” to the grade setting section 53. Note that if switching of the own path, or bandwidth control, is performed due to degradation in the quality of the own path, the grade change path is changed to “Adjacent Path” and the action path is changed from Own Path to Adjacent Path in the “Grade Change path & Action path” information, which is output to the Ethernet OAM generation section 54 provided for the VLAN group of the adjacent path.

The grade setting section 53, upon receipt of “Invalid” for grade setting from the L2 path control section 58, discards the result of pattern matching received from the traffic quality recognition section 52 and passes the information of Invalid to the Ethernet OAM generation section 54. The Ethernet OAM generation section 54 having received the information of Invalid does not generate an Ethernet OAM frame based on information from the grade setting section 53 until the information of Invalid is canceled.

The Ethernet OAM generation section 54, upon receipt of the TLV information from the L2 path control section 58, generates a VSM Ethernet OAM frame based on the TLV information and passes the generated Ethernet OAM frame to the L2 switch section 55. The L2 switch section 55 having received this Ethernet OAM frame performs L2 switching processing and passes the Ethernet OAM frame to the egress QoS section 56.

As described above, the L2 switch section 55 having received the protection switching information from the L2 path control section 58, based on the protection switching information, performs protection switching for the VLAN path of the VLAN group B adjacent to the VLAN group A whose communication quality has degraded so that transmission routes are switched from the primary route, VLAN path B 43, to the secondary route, VLAN path B 44. Communication traffic of the VLAN path B for which routes have been thus switched is subjected to QoS processing by the egress QoS section 56 and sent out to the core node 21 that is an adjacent node through which the VLAN path B 44 passes.

### 2.5.2) Operation of Edge Node 12

As described with FIG. 2, a single node is provided with the ingress QoS sections 51 respectively corresponding to links with adjacent nodes. Accordingly, hereinafter, a description will be given of the ingress QoS section 51, traffic quality recognition section 52, grade setting section 53, and Ethernet OAM generation section 54 related to a port on the edge node 11 side.

In the edge node 12, the ingress QoS section 51 provided to the port on the edge node 11 side receives the communication traffic from the edge node 11, performs QoS processing, and outputs the communication traffic to the traffic quality recognition section 52 and L2 switch section 55. At this time, rate control is not performed because no rate control information is indicated from the L2 path control section 58.

The traffic quality recognition section 52, upon receipt of the communication traffic from the ingress QoS section 51, performs pattern matching with a plurality of patterns to determine the quality of the traffic. Since the received communication traffic contains a factor for quality degradation such as a virus, a match occurs with a virus data pattern, and the quality is recognized as Degrade. This pattern matching result is output to the grade setting section 53.

The grade setting section 53, since the port is not on a client network-side one, receives information of Invalid for grade setting from the L2 path control section 58, discards the received pattern matching result, and passes the information of Invalid to the Ethernet OAM generation section 54. Accordingly, the Ethernet OAM generation section 54 does not perform Ethernet OAM generation.

The L2 switch section 55 receives the communication traffic from the ingress QoS section 51, performs L2 switching processing, and passes the communication traffic to the egress QoS section 56. Moreover, when the communication traffic received from the ingress QoS section 51 contains Ethernet OAM, the L2 switch section 55 performs L2 switching processing on the Ethernet OAM frame and passes it to the Ethernet OAM termination section 57.

The egress QoS section 56, upon receipt of the communication traffic from the L2 switch section 55, performs QoS processing and sends the communication traffic out to the client network 3. At this time, rate control is not performed because no rate control information is indicated from the L2 path control section 58.

The Ethernet OAM termination section 57, upon receipt of the VSM Ethernet OAM frame from the L2 switch section 55, checks the normality of the Ethernet OAM frame and passes VSM TLV information in the Ethernet OAM frame and information on the source of the Ethernet OAM frame to the L2 path control section 58.

The L2 path control section 58, since the TLV information received from the Ethernet OAM processing section 57 is that of VSM and the information on the source of the Ethernet OAM frame is another node, passes protection switching information to the L2 switch section 55 based on the action ID when the action path in the “Grade Change Path & Action Path” information is Own Path, and also passes VSR TLV information to the Ethernet OAM generation section 54 corresponding to the path of the VLAN group from which the Ethernet OAM frame is received. When the action path in the “Grade Change Path & Action Path” information is Adjacent Path, the L2 path control section 58 does not perform the action and passes VSR TLV information to the Ethernet OAM generation section 54 corresponding to the path of the VLAN group from which the Ethernet OAM frame is received.

The Ethernet OAM generation section 54 having received the TLV information from the L2 path control section 58 generates a VSR Ethernet OAM frame based on the TLV information and passes the generated Ethernet OAM frame to the L2 switch section 55. The L2 switch section 55 having received this Ethernet OAM frame performs L2 switching processing and outputs the Ethernet OAM frame to the egress QoS section 56.

The L2 switch section 55 having received the protection switching information from the L2 path control section 58 performs protection switching of the VLAN path in question based on the protection switching information, thereby switching transmission routes for Primary→Secondary or Secondary→Primary.

### 2.5.3) Secondary Route of VLAN Path B

Regarding communication traffic from the client network 2 toward the client network 4, since there is no factor for quality degradation, the communication traffic, on the functional blocks in FIG. 4, is passed from the ingress QoS section 51 to the L2 switch section 55 and then sent from the L2 switch section out to the network 1 via the egress QoS section 56. Thereafter, the communication traffic is sequentially transferred from a node to another within the network 1 to arrive at the edge node 13, from which the communication traffic is sent out to the client network 4.

As described above, when degradation in the quality of communication traffic is detected in a path of the VLAN group A, it is possible to switch the communication route of the VLAN group B, by using an Ethernet OAM frame, from an output port of the primary route 33, which goes from the edge node 11 toward the edge node 12, to an output port of the secondary route 44, which goes toward the core node 21. In addition, the edge node 11 transmits to the edge node 13, along with the communication traffic of the VLAN path B 44, a VSM Ethernet OAM frame in which the “Grade Change Path & Action Path” information is “Adjacent Path & Own Path” and the Action ID information is protection switching information of “Primary→Secondary.”

First, at the core node 21 that has received this Ethernet OAM frame, since the Ethernet OAM frame is not destined for itself, the Ethernet OAM frame is not passed to the Ethernet OAM termination section 57 but is transferred as it is to the downstream core node 24. The Ethernet OAM frame is similarly transferred at the core node 24 and also at the further downstream core node 23, eventually arriving at the edge node 13.

The edge node 13, based on the TLV information in the received VSM Ethernet OAM frame, performs protection switching of the path of the VLAN group B, which is the own path, generates a VSR Ethernet OAM frame, which is a response to the VSM Ethernet OAM frame, and transmits the VSR Ethernet OAM frame to the edge node 11.

The VSR Ethernet OAM frame destined for the edge node 11 is similarly sequentially transferred to the core nodes 23, 24, and 21 within the network 1, arriving at the edge node 11.

The edge node 11 checks the received VSR Ethernet OAM frame and manages whether or not VSR Ethernet OAM frames are all sent back to VSM Ethernet OAM frames transmitted. When all responses are sent back, the action attributable to degradation in the quality of the communication traffic is finished, and the L2 path control section 58 allows the grade setting section 53 to change the information of Invalid, which has been set to suppress generation of an Ethernet OAM frame for the same reason, to Valid.

### 2.6) Effects

As described above, according to the present embodiment, a mechanism for acquiring quality information on communication traffic from a upper layer is provided, whereby it is possible to ensure the quality of the upper layer at the Layer 2 network level. Moreover, by using the Ethernet OAM, it is possible to seamlessly perform management and operation at a Layer 2 network independently of Layer 1 network devices.

Moreover, an action (route switching, bandwidth control, and the like) based upon quality information on communication traffic written in an Ethernet OAM frame is performed, whereby it is possible to ensure the quality of a upper layer at a Layer 2 network. For example, it is possible to share quality information between different paths, by rewriting a parameter of the “Grade Change Path & Action Path” information. Accordingly, upon detection of a virus in the VLAN path A at the edge node 11, it is possible to switch the adjacent VLAN path B, not the VLAN path A whose quality has degraded, from the primary route to the secondary route. Therefore, in addition to ensuring the quality of the upper layer, it is also possible to flexibly operate a network.

### 3. Other Examples

The communication control device according to the above-described first example has a function of assuring path quality at Layer 2, based upon quality information on a upper layer of communication traffic. However, the present invention is not limited to ensuring of quality at Layer 2, but it is also possible to implement a quality ensuring function at Layer 1 as described below.

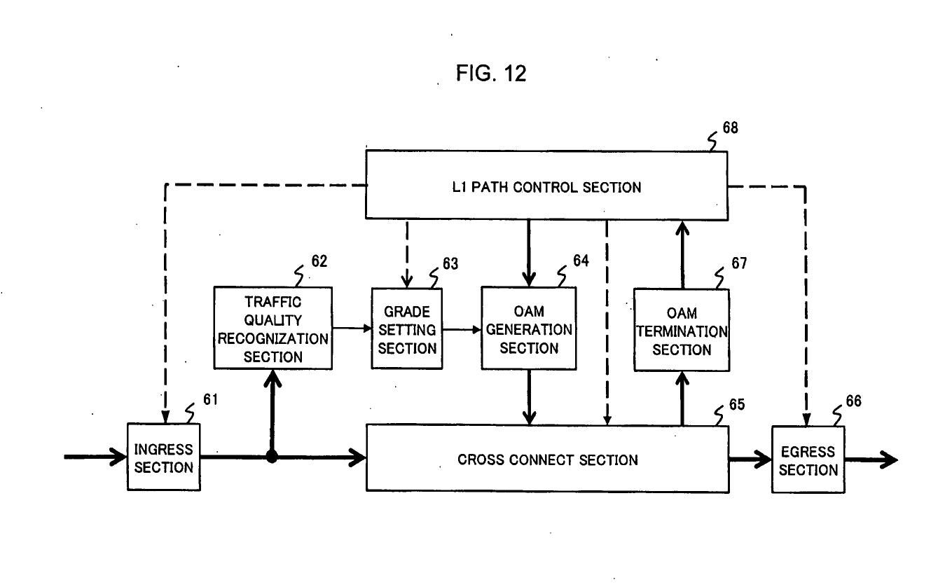

As shown in FIG. 12, a node according to a second example of the present invention includes an ingress section 61, a traffic quality recognition section 62, a grade setting section 63, an OAM generation section 64, a cross-connect section 65, an egress section 66, an OAM termination section 67, and a L1 path control section 68. Since the basic topology of these sections is similar to the first example shown in FIG. 4, a description thereof will be omitted.

The ingress section 61 has a function of checking the state of an input signal. For example, in SDH (Synchronous Digital Hierarchy), the quality of a SDH channel is checked using an overhead byte such as RSOH (Regenerator Section Over Head) or MSOH (Multiplex Section Over Head).

The traffic quality recognition section 62 and grade setting section 63 have the same functions as the traffic quality recognition section 52 and grade setting section 53 of the first example, respectively.

At Layer 1, the OAM generation section 64 generates an OAM of a path at Layer 1 (an OAM using the path overhead (POH: Path Over Head) in SDH). The cross-connect section 65 corresponds to the L2 switch section 55 of the first example and has a function of statically switching or dynamically switching under the L1 path control section 68 in a Layer 1 network. The egress section 66 has a function of generating and inserting an OH byte. The OAM termination section 67 has a function reverse to the OAM generation section 64, that is, a function of terminating a path OH. The L1 path control section 68 has a function of controlling paths at Layer 1. In SDH, the L1 path control section 68 has a function like SCC (Section Connection Control) realizing APS (Automatic Protection Switch).

Thus configured, it is possible to guarantee path quality at Layer 1 based on quality information on a upper layer in communication traffic.

As another example, for Action ID in the TLV information, OAM PDU Type of APS, which is defined for Ethernet OAM frames, is applied, whereby it is possible to implement an APS function.

Moreover, in the above-described examples, a terminal point is an edge node, assuming that VLAN paths are connection oriented. However, the present invention can also be applied to full-mesh networks by terminating a VLAN path at each node, assuming connectionless communication.

### INDUSTRIAL APPLICABILITY

The present invention can be applied to communication networks such as optical networks and Ethernet networks.

### REFERENCE SIGNS LIST

101 Lower-layer switch section
102 Input section
103, 104 Output section
105, 106 Upper-layer quality detection section
107 Lower-layer control section
51 Ingress QoS section
52 Traffic quality recognition section
53 Grade setting section
54 Ethernet OAM generation section
55 L2 switch section
56 Egress QoS section
57 Ethernet OAM termination section
58 L2 path control section
61 Ingress section
62 Traffic quality recognition section
63 Grade setting section
64 OAM generation section
65 Cross-connect section
66 Egress section
67 OAM termination section
68 L1 path control section

1. A communication device in a network including a plurality of communication devices, comprising:
a detection section for detecting quality information of communication traffic at an upper layer higher than a predetermined layer; and
a control section for controlling communication of the predetermined layer based on the quality information of the upper layer so as to guarantee communication quality of the upper layer.

2. The communication device according to claim 1, wherein when a plurality of paths passing through the communication device coexist, the control section shares the quality information of the upper layer in respect to path control between the plurality of paths.

3. The communication device according to claim 2, wherein the control section switches a route of a path other than a path in which the communication quality of the upper layer has degraded.

4. The communication device according to claim 2, wherein the predetermined layer comprises Layer 2, and the control section performs path route switching control based on the quality information of the communication traffic in Ethernet (trademark) OAM (operations, administration, maintenance).

5. The communication device according to claim 1, wherein the control section performs path bandwidth control based on the quality information of the upper layer.

6. A communication control method for a communication device in a network including a plurality of communication devices, comprising:
detecting quality information of communication traffic at an upper layer higher than a predetermined layer; and
controlling communication of the predetermined layer based on the quality information of the upper layer so as to guarantee communication quality of the upper layer.

7. The communication control method according to claim 6, wherein when a plurality of paths passing through the communication device coexist, the quality information of the upper layer of these paths is shared in respect to path control between the plurality of paths.

8. The communication control method according to claim 7, wherein a route of a path other than a path in which the communication quality of the upper layer has degraded is switched.

9. The communication control method according to claim 7, wherein the predetermined layer comprises Layer 2, and path route switching control is performed based on the quality information of the communication traffic in Ethernet (trademark) OAM (operations, administration, maintenance).

10. The communication control method according to claim 6, wherein path bandwidth control is performed based on the quality information of the upper layer.

11. A communication system in which a plurality of communication devices are connected in a network, wherein each of the plurality of communication devices comprises:
a detection section for detecting quality information of communication traffic at an upper layer higher than a predetermined layer; and
a control section for controlling communication of the predetermined layer based on the quality information of the upper layer so as to guarantee communication quality of the upper layer.

12. The communication system according to claim 11, wherein when a plurality of paths passing through the communication device coexist, the control section shares the quality information of the upper layer of in respect to path control between the plurality of paths.

13. The communication system according to claim 12, wherein the control section switches a route of a path other than a path in which the communication quality of the upper layer has degraded.

14. The communication system according to claim 12, wherein the predetermined layer comprises Layer 2, and the control section performs path route switching control based on the quality information on the communication traffic in Ethernet (trademark) OAM (operations, administration, maintenance).

15. The communication system according to claim 11, wherein the control section performs path bandwidth control based on the quality information of the upper layer.

16-20. (canceled)
